(19) United States
(12) Patent Application Publication
(10) Pub. No.: US 2021/0245672 A1
(43) Pub. Date: Aug. 12, 2021

(54) BIKE RACK FOR A MOTOR VEHICLE

(71) Applicant: George Jerzy Dratewski, Franklin Park, IL (US)

(72) Inventor: George Jerzy Dratewski, Franklin Park, IL (US)

(21) Appl. No.: 17/091,319

(22) Filed: Nov. 6, 2020

Related U.S. Application Data
(60) Provisional application No. 62/974,443, filed on Dec. 10, 2019.

(51) Int. Cl. B60R 9/10; B62H 5/00

(52) U.S. Cl. CPC B60R 9/10; B62H 5/005

(57) ABSTRACT

Devices and methods are disclosed for securely locking a bike to a bike rack, and in some embodiments for locking the bike rack to a vehicle. In one embodiment, the bike rack includes a locking stud that matches a removable security handle for locking a bike to the bike rack. In another embodiment, a locking stud matches a removable security handle for locking the bike rack to the vehicle. In certain embodiments, the locking stud is flush with a housing of the locking stud, or can be at least partially recessed within the housing. In some embodiments, the bike rack includes a down tube support and a chainstay support.

### RELATED APPLICATION

This application incorporates in its entirety, and hereby claims priority to, application 62/974,443 filed Dec. 10, 2019, titled BICYCLE CARRIER/SECURITY HANDLE/ADDITIONAL CHAINSTAYS SUPPORT.

### BACKGROUND

### 1. Technical Field

Embodiments of the invention disclosed generally relate to systems and associated methods for transporting bicycles on vehicles. More specifically inventive systems and methods disclosed here relate to a bike carrier with improved, among other things, security and bike support features.

### 2. Description of the Related Art

A bicycle carrier (also commonly called a “bike rack”) is a device that attaches to a motor vehicle (such as an automobile, truck, SUV, RV, bus, etc.) for transporting a bike. Racks are typically mounted to the roof, front, or rear of the vehicle, and one or more bikes are clamped or strapped to the bike rack. One type of bike rack mounts to the tow hitch of the vehicle.

U.S. Pat. No. 9,371,042 titled “Apparatus for Connecting a Bicycle to a Motor Vehicle and Method of Use”, granted to the present inventor on Jun. 21, 2016, is hereby incorporated herein in its entirety.

### SUMMARY OF ILLUSTRATIVE EMBODIMENTS

Disclosed are systems and methods for securely locking a bike to a bike rack, and for securely locking the bike rack to a vehicle. As used here, the term “securely” means providing methods and mechanisms to lock or secure the bike and/or rack so as to make it more difficult for the bike and/or the rack to be stolen. This is to be differentiated from other meanings, such as for example, locking or clamping down the bike primarily as a means of holding the bike in attachment to the bike rack for transporting the bike.

In one aspect, the invention is directed to a method of securing and transporting on a vehicle a bike rack and a bike, the method including providing a vehicle having a tow hitch; providing a bike having a crank arm, a bottom bracket, a chainstay, and a down tube; providing a bike rack for carrying the bike, wherein the bike rack includes: (i) a clamp configured to clamp the crank arm, (ii) a bike locking stud configured to actuate the clamp, and (iii) a security locking handle configured to actuate the clamp by rotating the bike locking stud. The method further includes a rotating the security locking handle to close the clamp, through actuation of the bike locking stud, onto the crank arm; and removing the security locking handle from engagement with the bike locking stud.

In one embodiment, the method further includes providing the bike rack having a tow hitch beam configured to be removably received by the tow hitch; a locking pin configured to lock the tow hitch beam to the tow hitch; and a rack locking stud configured to actuate the locking pin. The method can also involve inserting the tow hitch beam into the tow hitch; wherein the security locking handle is further configured to actuate the locking pin by rotating the rack locking stud; rotating the security locking handle to actuate the locking pin, through actuation of the rack locking stud, to lock the bike rack to the tow hitch; and removing the security locking handle from engagement with the rack locking stud.

In some embodiments, the method can involve providing a chainstay support attached to the bike rack; supporting the chainstay with the chainstay support without locking down the chainstay to the chainstay support; providing a down tube support attached to the bike rack; and supporting the down tube with the down tube support without locking down the down tube to the down tube support.

In yet another embodiment, the method is addressed to providing the bike rack further having the bike locking stud configured to not extend outside a housing of the bike locking stud. The method can also include that the rack has a bike locking stud and the rack locking stud does not extend outside a respective housing of the bike locking stud and a housing of the rack locking stud.

In one embodiment, the method can also include that the bike rack further has a magnet coupled to the security locking handle, wherein the magnet is configured to secure engagement of the security locking handle to the bike locking stud and/or the rack locking stud.

Another aspect of the invention concerns a bike rack for transporting and securing a bike. The bike rack is securely lockable to a vehicle. The bike rack can include a clamp coupled to the bike rack, wherein the clamp is configured to removably clamp onto a crank arm of the bike; a bike locking stud coupled to the clamp and configured to open and close the clamp, onto and off the crank arm, through a rotation of the bike locking stud; and a security locking handle, wherein the security locking handle is configured to removably engage the bike locking stud and to rotate the bike locking stud to actuate the crank arm clamp to clamp the bike to the bike rack.

In one embodiment, the bike rack further includes a tow hitch beam removably coupled to a tow hitch of the vehicle; a rack locking stud positioned within the a tow hitch, wherein the rack locking stud is configured to be rotatable; a security pin coupled to the rack locking stud, wherein a rotation of the rack locking stud actuates the security pin to lock the tow hitch beam to the tow hitch; and wherein the security locking handle is configured to removably engage the rack locking stud and to rotate the rack locking stud to actuate the locking pin to lock the bike rack to the tow hitch.

In yet another embodiment, the bike rack includes a down tube support attached to the bike rack, wherein the down tube support supports the down tube without locking down the down tube. The bike rack can also include a chainstay support attached to the bike rack, wherein the chainstay support supports a chainstay of the bike without locking down the chainstay. In certain embodiments, the chainstay support includes an arm configured to be vertically adjustable, and wherein the arm is further configured to be rotatable on a horizontal plane. The chainstay support can also have a support ledge configured to be in direct contact with the chainstay, and wherein the support ledge is further configured to be rotatable. In one embodiment, the bike rack includes a bottom bracket support to support a bottom bracket of the bike.

In one embodiment, the bike rack has a chainstay support attached to the bike rack, wherein the chainstay support supports a chainstay of the bike without locking down the chainstay and a down tube support attached to the bike rack, wherein the down tube support supports the down tube without locking down the down tube.

In certain embodiments, the bike locking stud is configured to not extend outside a housing of the bike locking stud. In yet other embodiments, both the bike locking stud and the rack locking stud are configured to not extend outside a respective housing of the bike locking stud and a housing of the rack locking stud.

In another embodiment, the bike rack has a magnet coupled to the security locking handle, wherein the magnet is configured to secure engagement of the security locking handle to the bike locking stud and/or the rack locking stud.

In some embodiments, the invention is addressed to a bike rack for transporting a bike, the bike rack securely lockable to a vehicle. The bike rack includes a tow hitch beam removably coupled to a tow hitch of the vehicle; a rack locking stud positioned within the a tow hitch, wherein the rack locking stud is configured to be rotatable; a security pin coupled to the rack locking stud, wherein a rotation of the rack locking stud actuates the security pin to lock the tow hitch beam to the tow hitch; and a security locking handle, wherein the security locking handle is configured to removably engage the rack locking stud and to rotate the first locking stud to actuate the locking pin to lock the bike rack to the tow hitch.

In one embodiment the rack locking stud is configured to not extend outside a housing of the bike locking stud. The bike rack can also include a magnet coupled to the security locking handle, wherein the magnet is configured to secure engagement of the security locking handle to the rack locking stud.

The above as well as additional features and advantages of the present invention will become apparent in the following detailed written description.

### BRIEF DESCRIPTION OF THE DRAWINGS

The invention itself will best be understood by reference to the following detailed description of an illustrative embodiment when read in conjunction with the accompanying drawings, wherein:

FIG. 1 is a left side elevation of reduced view of a bike securely locked to a bike rack.

FIG. 2 is a perspective view of a portion of the bike rack securely locked to a tow hitch.

FIG. 3 is a perspective view of a portion of the bike rack with a security locking handle in the engaged position and a locking pin extending out.

FIG. 4 is a perspective view of the security locking handle and a portion of a locking stud.

FIG. 5 is another perspective view of the security locking handle with the portion of the locking stud.

### DETAILED DESCRIPTION OF ILLUSTRATIVE EMBODIMENTS

In the following detailed description of exemplary embodiments of the invention, specific exemplary embodiments in which the invention may be practiced are described in sufficient detail to enable those skilled in the relevant technology to practice the invention, and it is to be understood that other embodiments may be used and that mechanical, electrical and other changes may be made without departing from the spirit or scope of the present invention.

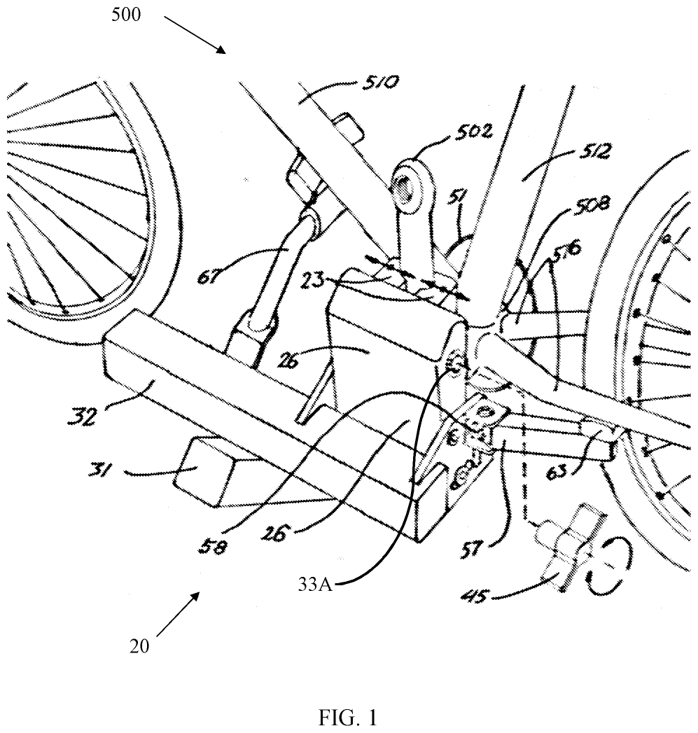

FIG. 1 shows one embodiment of a bike security system according to the inventive principles disclosed herein. Bike 500 includes a crank arm 502, a bottom bracket 508, a down tube 510, chainstays 516, and a seat tube 512. Bottom bracket 508 is connected to down tube 510, seat tube 512, and chainstays 516. A chain ring 51 is located on the right side of bike 500. For clarity the pedals and bike chain are not shown.

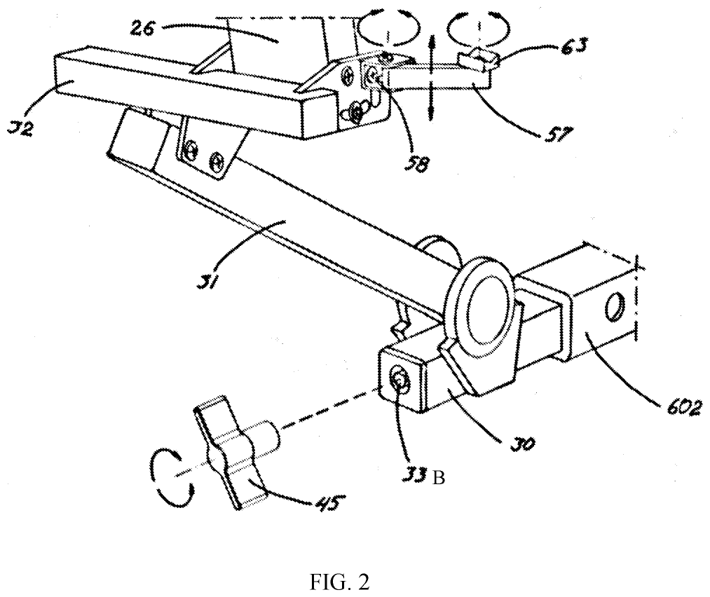

Referencing FIG. 1 and FIG. 2, a bike rack 20 includes a hitch beam 30 which is rotatably connected to a linking beam 31, which link beam 31 is coupled to a bike support beam 32. Hitch beam 30 is configured to be removably received by a tow hitch 602. Bike rack 20 supports bottom bracket 508. In one embodiment, bike rack 20 includes a clamp 26 for clamping crank arm 502. Clamp 26 includes movable jaws 23. A security locking handle 45 is configured to open and close jaws 23 through activation of a bike locking stud 33A.

In one embodiment, linking beam 31 is configured to be used in four different positions. In a first position (not shown), linking beam 31 can be positioned perpendicular to hitch beam 30 when the rack 20 is not being used to transport bike 500. In a second position (not shown), linking beam 31 extends away from tow hitch 602 to allow access to the back door or trunk of vehicle 600 (for vehicle 600 depiction reference U.S. Pat. No. 9,371,042). In a third position (not shown), linking beam 31 folds over hitch beam 30, towards the end of hitch beam 30 that inserts into tow hitch 602, for convenient storage. In a fourth position (FIG. 1), linking beam 31 is positioned to suitably support bike support beam 32 for transporting bike 500.

In one embodiment, clamp 26 includes a threaded member (not shown) having a bike locking stud 33A configured to be removably coupled to security locking handle 45. The threaded member has both left handed and right handed threads. One jaw 23 engages left handed threads, and the other jaw 23 engages right handed threads. Because of the left and right handed threads, jaws 23 symmetrically travel away from each other when security locking handle 45 is turned to open jaws 23, and symmetrically travel toward each other when security locking handle 45 is turned to close jaws 23. For an example of a suitable threaded member that can be adapted for this purpose, see U.S. Pat. No. 9,371,042.

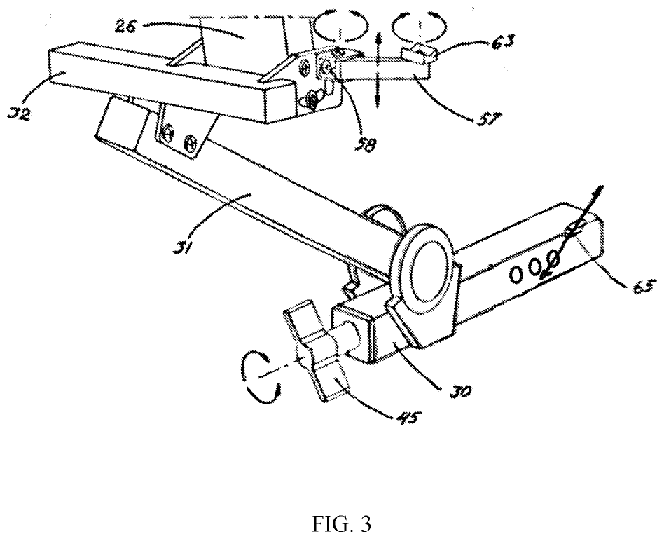

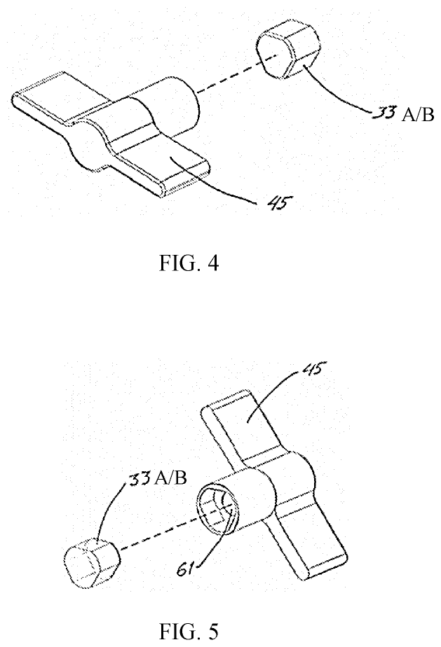

A rotation of security locking handle 45 causes bike locking stud 33A to rotate jaws 23, which then clamp crank arm 502. After removing security handle 45, bike 500 is securely locked to rack 20. In one embodiment, the same security locking handle 45 is configured to engage a rack locking stud 33B, which rack locking stud 33B is positioned within hitch beam 30. A distal end of rack locking stud 33B is configured to actuate a locking pin 65 (FIG. 3). After removing security handle 45 from rack locking stud 33B, bike rack 20 is securely locked to tow hitch 602. Thus, security handle 45 can act as a locking key for both bike 500 and bike rack 20. In one embodiment, security locking handle 45 includes a magnet 61 (FIG. 5) that keeps security locking handle 45 engaged to bike locking stud 33A and/or rack locking stud 33B. The female shape of the opening of security locking handle 45 and the matching male shape on bike locking stud 33A or rack locking stud 33B (FIG. 4, FIG. 5) are used as examples, and many other shapes can be used.

In one embodiment, bike rack 20 includes a chainstay support 57 and a down tube support 67. Down tube support 67 supports down tube 510, and chainstay support 57 supports chainstay 516. The cooperation between chainstay support 57 and down tube support 67 eliminates the need to clamp down tube 510 to down tube support 67. By supporting the back and the front of bike 500, bike 500 can be secured to bike rack 20 in a single operation, which is clamping crank arm 502 by jaws 23 through the rotation of security locking handle 45.

In one embodiment, security locking handle 45 engages bike locking stud 33A (FIG. 2), which is the top part of a threaded member (not shown). The threaded member can be, for example, a screw with both right hand threads and left hand threads. Rotation of security locking handle 45 rotates the threaded member clockwise (which has both left and right threads) causing jaws 23 to clamp crank arm 502. To prevent bike 500 from rotating around bottom bracket 508, down tube support 67 supports down tube 510, and chainstay support 57 supports chainstay 516. Chainstay support 57 can be adjusted up and down using bolt 58. Chainstay support 57 is configured to swing in the horizontal plane to be suitably positioned under chainstay 516. Chainstay support 57 has a support ledge 63 that is in contact with chainstay 516. In one embodiment, support ledge 63 is rotatable and can be aligned with chainstay 516 (FIGS. 1, 2 and 3). In some embodiments, chainstay support 57 can be folded back for storage.

FIG. 2 and FIG. 3 show security locking handle 45 used to lock hitch beam 30 to tow hitch 602. Rotating security locking handle 45 (in engaged position) clockwise causes security pin 65 to expand outwards and to lock hitch beam 30 to tow hitch 602 (FIG. 3). The mechanism connecting rack locking stud 33B to security pin 65 is positioned inside the hitch beam 30. To clearly show security pin 65, the tow hitch 602 is not shown in FIG. 3. The mechanism that actuates security pin 65 can be, for example, a threaded rod with a wedge feature.

In one embodiment, security locking handle 45 includes a magnet 61 (FIG. 5) to ensure that security locking handle 45 stays engaged with rack locking stud 33B. The female shape of the opening of the security locking handle 45 and the matching male shape on the rack locking stud 33B (FIG. 4, FIG. 5) are used as examples. Security locking handle 45 can be disengaged (removed) and acts as a locking key for both bike 500 and bike rack 20.

In terms of use, a method for connecting a bicycle to a vehicle includes: (a) providing vehicle 600 having tow hitch 602; (b) providing bike 500 having crank arm 502, bottom bracket 508, chainstay 516, and down tube 510; (c) providing bike rack 20 for carrying bike 500 on vehicle 600, wherein bike rack 20 includes (i) bike support beam 32 coupled to clamp 26, (ii) tow hitch beam 30 suitably coupled to bike support beam 32 and configured to be removably received by tow hitch 602, (iii) locking pin 65 configured to lock tow hitch beam 30 to tow hitch 602, (iv) bottom bracket support 22 configured to receive bottom bracket 508, (v) bike locking stud 33A configured to actuate clamp 26, (vi) security locking handle 45 configured to actuate clamp 26 (through bike locking stud 33A), (vii) rack locking stud 33B configured to actuate locking pin 65 by a rotation of security locking handle 45; (d) inserting hitch beam 30 into tow hitch 602; (e) positioning bike 500 so that bottom bracket support 22 supports bottom bracket 508; (f) rotating security locking handle 45 to close clamp 26 (through actuation of bike locking stud 33A) onto crank arm 502; (g) rotating security locking handle 45 to actuate locking pin 65 (through actuation of rack locking stud 33B) to lock bike rack 20 to tow hitch 602; and (g) removing security locking handle 45 from engagement with bike locking stud 33A and/or rack locking stud 33B.

While the invention has been described with reference to exemplary embodiments, it will be understood by those skilled in the relevant technology that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention.

What is claimed is:

1. A bike rack for transporting and securing a bike, the bike rack securely lockable to a vehicle, the bike rack comprising:
a clamp coupled to the bike rack, wherein the clamp is configured to removably clamp onto a crank arm of the bike;
a bike locking stud coupled to the clamp and configured to open and close the clamp, onto and off the crank arm, through a rotation of the bike locking stud; and
a security locking handle, wherein the security locking handle is configured to removably engage the bike locking stud and to rotate the bike locking stud to actuate the crank arm clamp to clamp the bike to the bike rack.

2. The bike rack of claim 1, further comprising:
a tow hitch beam removably coupled to a tow hitch of the vehicle;
a rack locking stud positioned within the a tow hitch, wherein the rack locking stud is configured to be rotatable;
a security pin coupled to the rack locking stud, wherein a rotation of the rack locking stud actuates the security pin to lock the tow hitch beam to the tow hitch; and
wherein the security locking handle is configured to removably engage the rack locking stud and to rotate the rack locking stud to actuate the locking pin to lock the bike rack to the tow hitch.

3. The bike rack of claim 1, further comprising a down tube support attached to the bike rack, wherein the down tube support supports the down tube without locking down the down tube.

4. The bike rack of claim 3, further comprising a chainstay support attached to the bike rack, wherein the chainstay support supports a chainstay of the bike without locking down the chainstay.

5. The bike rack of claim 4, wherein the chainstay support comprises an arm configured to be vertically adjustable, and wherein the arm is further configured to be rotatable on a horizontal plane.

6. The bike rack of claim 4, further comprising a bottom bracket support to support a bottom bracket of the bike.

7. The bike rack of claim 6, wherein the chainstay support further comprises a support ledge configured to be in direct contact with the chainstay, and wherein the support ledge is further configured to be rotatable.

8. The bike rack of claim 2, further comprising:
a chainstay support attached to the bike rack, wherein the chainstay support supports a chainstay of the bike without locking down the chainstay; and
a down tube support attached to the bike rack, wherein the down tube support supports the down tube without locking down the down tube.

9. The bike rack of claim 1, wherein the bike locking stud is configured to not extend outside a housing of the bike locking stud.

10. The bike rack of claim 2, wherein both the bike locking stud and the rack locking stud are configured to not extend outside a respective housing of the bike locking stud and a housing of the rack locking stud.

11. The bike rack of claim 3, further comprising a magnet coupled to the security locking handle, wherein the magnet is configured to secure engagement of the security locking handle to the bike locking stud and/or the rack locking stud.

12. A bike rack for transporting a bike, the bike rack securely lockable to a vehicle, the bike rack comprising:
a tow hitch beam removably coupled to a tow hitch of the vehicle;
a rack locking stud positioned within the a tow hitch, wherein the rack locking stud is configured to be rotatable;
a security pin coupled to the rack locking stud, wherein a rotation of the rack locking stud actuates the security pin to lock the tow hitch beam to the tow hitch; and
a security locking handle, wherein the security locking handle is configured to removably engage the rack locking stud and to rotate the first locking stud to actuate the locking pin to lock the bike rack to the tow hitch.

13. The bike rack of claim 12, wherein the rack locking stud is configured to not extend outside a housing of the bike locking stud.

14. The bike rack of claim 12, further comprising a magnet coupled to the security locking handle, wherein the magnet is configured to secure engagement of the security locking handle to the rack locking stud.

15. A method of securing and transporting on a vehicle a bike rack and a bike, the method comprising:
providing a vehicle having a tow hitch;
providing a bike having a crank arm, a bottom bracket, a chainstay, and a down tube;
providing a bike rack for carrying the bike, wherein the bike rack comprises:
a clamp configured to clamp the crank arm;
a bike locking stud configured to actuate the clamp; and
a security locking handle configured to actuate the clamp by rotating the bike locking stud;
rotating the security locking handle to close the clamp, through actuation of the bike locking stud, onto the crank arm; and
removing the security locking handle from engagement with the bike locking stud.

16. The method of claim 12, the method further comprising:
wherein the bike rack further comprises:
a tow hitch beam configured to be removably received by the tow hitch;
a locking pin configured to lock the tow hitch beam to the tow hitch; and
a rack locking stud configured to actuate the locking pin;
inserting the tow hitch beam into the tow hitch;
wherein the security locking handle is further configured to actuate the locking pin by rotating the rack locking stud;
rotating the security locking handle to actuate the locking pin, through actuation of the rack locking stud, to lock the bike rack to the tow hitch; and
removing the security locking handle from engagement with the rack locking stud.

17. The method of claim 15, the method further comprising:
providing a chainstay support attached to the bike rack;
supporting the chainstay with the chainstay support without locking down the chainstay to the chainstay support;
providing a down tube support attached to the bike rack; and
supporting the down tube with the down tube support without locking down the down tube to the down tube support.

18. The method of claim 15, wherein providing the bike rack further comprises providing the bike locking stud configured to not extend outside a housing of the bike locking stud.

19. The method of claim 16, wherein providing the bike rack further comprises providing the bike locking stud and the rack locking stud configured to not extend outside a respective housing of the bike locking stud and a housing of the rack locking stud.

20. The method of claim 16, further comprising wherein providing a bike rack further comprises providing a magnet coupled to the security locking handle, wherein the magnet is configured to secure engagement of the security locking handle to the bike locking stud and/or the rack locking stud.
